(19) United States
(12) Patent Application Publication
(10) Pub. No.: US 2001/0039873 A1
(43) Pub. Date: Nov. 15, 2001

(54) Background music play device and method thereof for mobile station

(75) Inventors: Sang Yong Yi, Seoul (KR); Du Hyun Yoon, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 09/748,224

(22) Filed: Dec. 27, 2000

(30) Foreign Application Priority Data
Dec. 28, 1999 (KR) 63824/1999
Apr. 11, 2000 (KR) 19017/2000

(51) Int. Cl. G10H 1/26

(52) U.S. Cl. 84/610

(57) ABSTRACT

The present invention provides a background music play device equipped in a mobile station and methods for playing the background music capable of playing the background music during voice communication between two mobile stations. A background music play device for a mobile station of the present invention includes storage means for storing digital music file; music file play means for playing the digital music file stored in the storage means; output means for outputting voice of caller and music played by the music file play means; input means for inputting voice of receiver; control means which control signal transmittance and receipt, encoding signals to be transmitted and decoding signals received, and outputting the music as a background music according to user's selection. Using the mobile station equipped with the background music play device, specific background music is preset relative to each phone number set in the mobile station such that the preset background music is automatically played when a communication channel is established with the mobile station having one of the preset phone numbers.

### BACKGROUND OF THE INVENTION

(a) Field of the Invention

The present invention relates to a mobile station, and in particular, to a background music play device and method for the mobile station capable of playing background music during voice communication with a counterpart mobile station.

(b) Description of the Conventional Art

As shown in FIG. 1, a mobile station comprises an antenna 101 for receiving and transmitting radio frequency (RF) signals, an RF processing part 102 for converting incoming analog signals into digital signals using an analog-to-digital converter (ADC) and for converting outgoing digital signals into analog signals using a digital-to-analog converter (DAC), a mobile station modem (MSM) 103 for controlling the mobile station, a coder-decoder (CODEC) 104 for coding and decoding digital the signals, a speaker 105 ear phone jack 106 for outputting voice, and a micro phone for inputting user's voice.

The outgoing data processes are as follows.

Once the user's voice having a bandwidth of 300 Hz˜3.4 kHz is inputted through the microphone 107, it is processed by sampling process and digitalized in the CODEC 104 using a pulse code modulation and then the modulated signals is sent to the MSM 103. Consequently, the MSM 103 encodes the modulated signals using the Qualcomm Codebook Exited Linear Prediction (QCELP) algorithm in various data rate of 8 kbps and 13 kbps, and then sends the data to the RF processing part 102. The RF processing part 102 take the data from the MSM 103 on a carrier wave so as to transmit into air using a Code Division Multiple Access (CDMA) technology.

As explained above, the incoming signals are decoded in reverse order of the outgoing signal processes so as to be listened through the speaker 105 and earphone 106 by a counter part mobile station.

However, this conventional mobile station has only the voice communication function such that if the user wants to stop the communication during some period due to an indispensable situation, the counterpart user may feel boring without conversation. Even when the two users communicate with each other, they can feel monotonous during their conversation.

Recently, as the mobile communication is abruptly widespread and the mobile station becomes necessaries of life, the mobile stations starts to adapt additional functions. Besides the voice communication function, other functions such as a short message service, data storage function, special information services of weather and stock market information and so on, and internet access and web search are integrated into the mobile station.

Furthermore, as multimedia compression technologies such as the Moving Picture Experts Group (MPEG) are getting highly developed and the memory chips are getting smaller in size, it can be possible to store large data into the mobile station and to transfer the data to other mobile station or computer system in high speed data rate in near future. For example, many kinds of software programs that can play an MP3 audio file, which adapts the MPEG technology to the audio compression, has been spread all around world, and portable MP3 players are getting in place of the conventional cassette recorders.

### SUMMARY OF THE INVENTION

The present invention has been made in an effort to integrating an MP3 storage and player into the mobile station so as to play the stored MP3 files as background music during voice conversation.

The mobile station of the present invention comprises storage means for storing music data, control means for controlling so as to play the music data, and music data processing means for processing the music data under control of the play control means.

It is an object of the present invention to provided with a background music play device and method thereof for a mobile station, which is capable of playing background music during voice communication between two mobile stations.

It is other object of the present invention to provide with the background music play device and method thereof capable of playing the background music in such a way that the background music can be listened through the mobile station equipped with the background music play device without transmitting the background music to a counterpart mobile station.

It is still other object of the present invention to provided with the background music play device and method thereof capable of playing the background music in such a way that the background music is transmitted to the counterpart mobile station such that the background music can be listened through the both mobile stations during the voice communication.

Also, it is still other object of the present invention to provide the background music play device and method thereof capable of stopping playing the background music when the communication channel is established and restarting playing the background from a recorded point in time when the music paused after the voice communication channel is released according to a user's selection.

Finally, it is another object of the present invention to provide with the background music play device and method thereof capable of presetting the background music in relation to preset phone numbers such that preset background music is automatically played when a communication channel establishment is made with a counterpart mobile station having one of the preset phone numbers.

To achieved the above objects, the background music play device of the present invention comprises storage means for storing digital music file, music file play means for playing the digital music file stored in the storage means, output means for outputting voice of caller and music played by the music file play means, input means for inputting voice of receiver, control means which control signal transmittance and receipt, encoding signals to be transmitted and decoding signals received, and outputting the music as a background music according to user's selection.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram for illustrating a structure of conventional mobile station;

FIG. 2 is block diagram for illustrating a structure of a mobile station integrated with a background music play device according to the present invention;

FIG. 3 is a flow chart for illustrating a method for controlling background music play device of FIG. 2 according to a first preferred embodiment of the present invention; and

FIG. 4 is a flow chart for illustrating another method for controlling background music play device of FIG. 2 according to a second preferred embodiment of the present invention.

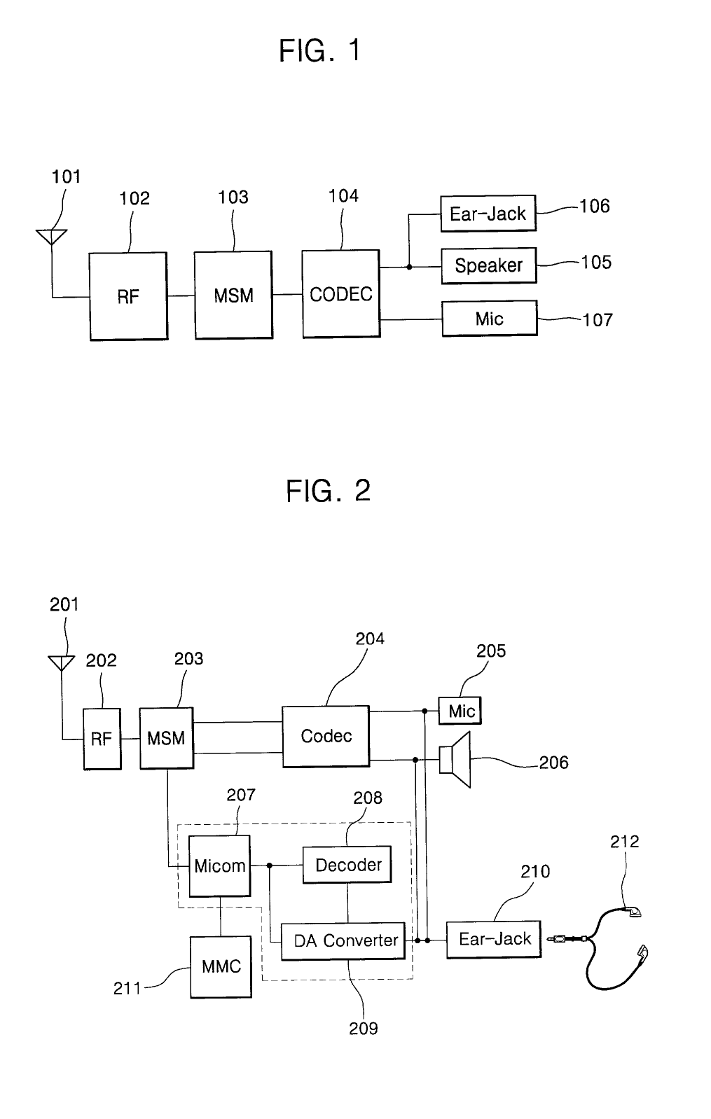

### DETAILED DESCRIPTION OF THE PREFERRED EMBODIMENTS

Preferred embodiments of the present invention will be described hereinafter with reference to the accompanying drawings.

FIG. 2 is block diagram for illustrating a mobile station integrated with a background music play device according to the present invention.

In FIG. 2, the mobile station of the present invention comprises an antenna 201 for receiving and transmitting RF signals, RF processing part 202 for processing the signals received and to be transmitted, a MSM 203 for controlling voice coding, channel coding, and power control of the mobile station, a microphone 205 for inputting voice, a speaker 206 for outputting voice, a CODEC 204 for coding analog signals into digital signals and decoding the digitals into analog signal, a multimedia card (MMC) 211 for storing MP3 data, a microcomputer 207 for controlling manipulation of the MP3 data, a decoder 208 for decoding the MP3 data into digital audio signals, a D/A converter 209 for converting the decoded digital audio signals into analog audio signals, and an ear-jack 210 for securing an earphone 212 so as to output the analog audio signals.

The ear-jack 210 is separately provided for listening to the MP3 music such that it differs from a jack for voice communication. Generally, the voice communication jack is electrically connected to the microphone 205 and the speak 206 for the voice communication.

The background music play operation of the above structured mobile station will be described with referenced to FIG. 2 hereinafter.

When the background music play function is required, the function is activated by selecting “on” in a background music manual window by button manipulation in state of the multimedia card 211 being installed into the mobile station. After the function is activated, if a music data file stored in the multimedia card 211 is selected, the microcomputer 207 read the selected music file and send the same to the decoder 208 such that the music file is decoded into digital audio signals by the decoder 208 and then the digital audio signals are sent to the D/A converter 209. The D/A converter 209 converts the digital audio signals from the decoder 208 into analog audio signals so as to send the converted analog audio signals to the CODEC 204, the speaker 206, and the ear-jack 210.

The CODEC 204 mixes the analog audio signals from the D/A converter 209 with voice signals input through the microphone 206, samples the mixed signal, and converts the mixed signal into PCM data. The PCM data is transmitted to the MSM 203 such that the MSM 203 encodes the PCM data using the QCELP algorithm and sends the coded data to the RF processing part 202 in data rate of 8 kbps or 13 kbps. The RF processing part 202 converts the data from the MSM 203 into the analog signals and then transmits the signals in forms of CDMA frames into the air through the antenna 201. The RF signals is received by an expected mobile station, decoded, and demodulated in the reverse order of the transmission processes such that it is possible for the counterpart user to listen to the voice and music at the same time through the speaker 206 and the ear-jack 210.

During these processes, the background music signals from the D/A converter 209 can be outputted through the speaker 206 or the ear-jack 210 of the mobile station.

The background music play method according to a first preferred embodiment of the present invention will be described hereinafter.

The background music play method of the mobile station of the present invention comprises the steps of determining whether the music is stopped or not when a communication channel establishment with another mobile station is required when the music is being played, communicating while music is playing if it is determined to continue playing the music, and communicating without the background music if it is determined to stop playing the music.

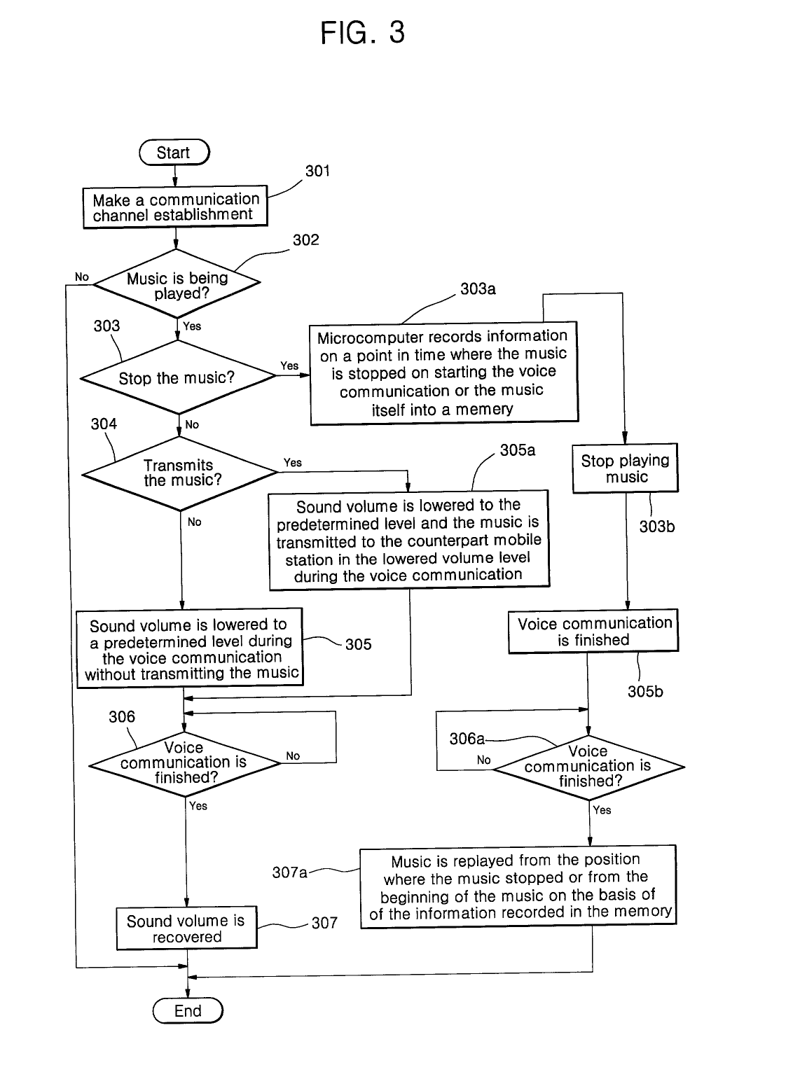

FIG. 3 is a flow chart for illustrating a method for controlling background music play device according to a first preferred embodiment of the present invention.

As shown in FIG. 3, once the mobile station equipped with the background music play device is requested to make a communication channel establishment at step 301, the microcomputer 207 determines if music is being played or not at step 302. If no music is being played, a normal communication channel establishment process is performed. If music is being played, it is determined whether to stop the music during the voice communication according to the user's button manipulation or a preset algorithm at step 303.

If it is determined to continuously play music during the voice communication, it is determined whether the mobile station transmits the music to the counterpart mobile station together with the voice at step 304. In music play mode, whether the music to be transmitted or not can be determined automatically or by the button manipulation.

If it is determined not to transmit the music, sound volume is lowered to a predetermined level during the voice communication without transmitting the music at step 305. While, if it is determined to transmit the music to the counterpart mobile station, the sound volume is lowered to the predetermined level and the music is transmitted to the counterpart mobile station in the lowered volume level during the voice communication at step 305a.

Consequently, it is determined whether the voice communication is finished at step 306, and the sound volume is recovered if the voice communication is finished at step 307.

At step 303, if it is determined to stop playing music, the microcomputer 207 records information on a point in time where the music is stopped on starting the voice communication or the music itself into a memory at step 303a and then stop playing music at step 303b. Consequently, the voice communication continues without playing music at step 305b and then it is determined whether the voice communication is finished or not at step 306a. If the voice communication is finished, the music is replayed from the position where the music stopped or from the beginning of the music on the basis of the information recorded in the memory at step 307a.

At step 303a, it is preferred that the point where the music is stopped is the time when the phone rings.

In this way, it is possible to have a conversation while listening to the background music.

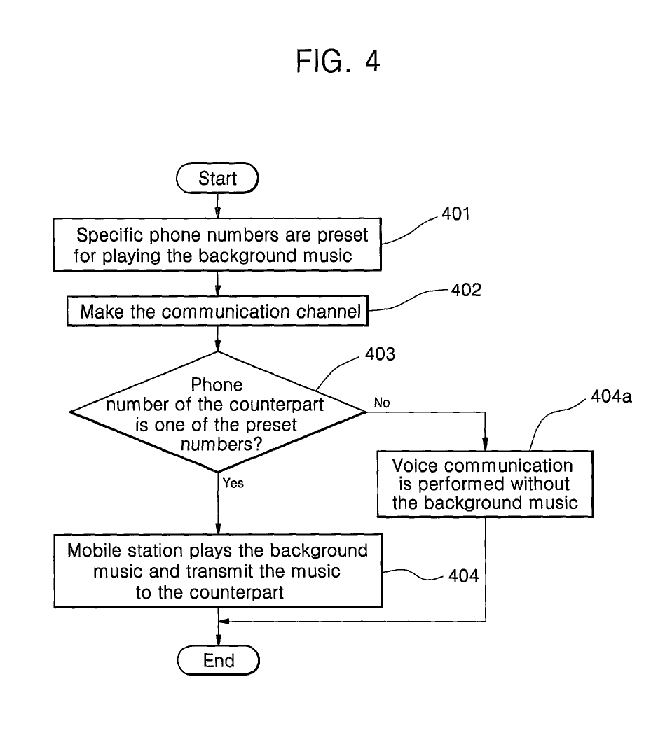

The background music playing method according to a second preferred embodiment of the present invention will be described with reference to FIG. 4 hereinafter.

In the second preferred embodiment of the present invention, the background music play device can be set in such a way that the background music is played only when communicating with a mobile station having one of preset phone numbers.

The background music playing method of the second preferred embodiment of the present invention comprises the steps of setting specific phone numbers for playing the background music only when communicating with the mobile station having one of the preset phone numbers, determining if the phone number of a counterpart mobile station is one of the preset numbers for playing the background music, performing voice communication while transmitting the background music to the counterpart mobile station if the number of the counterpart mobile station is one of the preset numbers.

FIG. 4 is a flow chart for illustrating a background music play method according to another preferred embodiment of the present invention.

Firstly, specific phone numbers are preset for playing the background music only when the mobile station is requested to make a communication channel with the mobile station having one of the preset phone numbers at step 401. After the preset is finished, if the mobile station is requested to make the communication channel at step 402, it is determined if the phone number of the counterpart is one of the preset numbers at step 403. If it is determined that the number of the counterpart is not one of the preset numbers, the voice communication is performed without the background music at step 404a. While, if it is determined that the number of the counterpart is one of the preset numbers at step 403, the mobile station plays the background music and transmit the music to the counterpart at step 404.

The background music play device can be installed to and uninstalled from the mobile station and can download and play music files provided by service providers.

Also, the music can be selectively played among the music files stored in the memory, and the background music can be automatically selected according to the phone number of the counterpart user. As explained above, the background music can be selectively played according to the phone numbers when the mobile station required to make a communication channel establishment and the background music can be selected among the music files stored in the memory by the user, and the background music can be randomly selected according to the phone number of channel establishment requester. Also it is possible to set so as to select and play a music file as a background music during the voice communication when the input number for requesting the communication channel establishment is one of the preset numbers. The point to begin playing the background music is when the communication channel is established.

As described above, in the mobile station equipped with the background music play device, the background music can be heard during the voice communication by the two communicators such that the background music help the conversation to be smooth and comfort, resulting in enhancing communication quality. Also, since the background music play method for mobile station of the present invention can play background music automatically, make possible to have conversation while the music is being played, and keep playing music after the communication channel is released, it can satisfy the various user requirements.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A background music play device for a mobile station comprising:
storage means for storing digital music file;
music file play means for playing the digital music file stored in the storage means;
output means for outputting voice of caller and music played by the music file play means;
input means for inputting voice of receiver;
control means which control signal transmittance and receipt, encoding signals to be transmitted and decoding signals received, and outputting the music as a background music according to user's selection.

2. A background music play device of claim 1 wherein the control means output the music through the output means of the mobile station.

3. A background music play device of claim 1 wherein the control means transmits the music to a counterpart user together with voice such that the user and a counterpart user listens to the music during voice communication.

4. A background music play device of claim 1 wherein the storage means is a card type storage.

5. A background music play device of claim 1 wherein the output means is a speaker and/or ear-jack.

6. A background music play device of claim I wherein the music file play means comprises a decoding means for decoding music data into digital signals, a D/A converter for converting the decoded digital signals into analog signals, and a microcomputer for controlling the music file play means and the D/A converter.

7. A background music play device of claim 1 wherein the music file is formatted in MP3 compression.

8. A background music play method in a mobile station equipped with a background music play device comprising the steps of:
determining to stop playing music when voice communication is initialized while music is being played;
performing voice communication with counterpart user while the music is being played if it is determined to play music during the voice communication; and
performing voice communication with counterpart user without playing music if it is determined to not play music during the voice communication.

9. A background music play method of claim 8 wherein if it is determined to keep playing music, the voice communication is performed while sound volume of the music is lowered to a predetermined level, and the sound volume of the music is recovered after the voice communication finishes.

10. A background music play method of claim 9 wherein the music is transmitted to the counterpart user such that the counterpart user can hear the music during the voice communication.

11. A background music play method of claim 8 wherein if it is determined to stop playing music, a point in time when the music pauses on starting voice communication is recorded.

12. A background music play method of claim 11 wherein a start point of the voice communication is when the mobile station rings.

13. A background music play method of claim 8 if it is determined to stop playing music, a point in time when the music pauses on starting voice communication is recorded and the music is replayed from the recorded point after the voice communication finishes.

14. A background music play method in a mobile station equipped with a background music play device comprising the steps of:
setting phone numbers for automatically playing background music when communicating with a counterpart user having the preset numbers;
determining if the counterpart mobile station has one of the preset numbers;
playing and transmitting background music during voice communication if it is determined the counterpart user has one of the preset numbers.

15. A background music play method of claim 14 wherein phone numbers are set in relation to specific background music to be played during the voice communication such that the preset music is played and transmitted to the counterpart user when the number is selected to establish a voice communication channel.

16. A background music play method of claim 15 wherein the background music is preset for each phone number.

17. A background music play method of claim 15 wherein the background music to be played is determined by comparing a received phone number to the preset phone numbers.

18. A background music play method of claim 15 wherein the background music to be played is determined by comparing a number entered by the user to the preset phone numbers.

19. A background music play method of claim 15 wherein the background music is played on the communication channel being established.
